(19) United States
(12) Patent Application Publication
(10) Pub. No.: US 2008/0285258 A1
(43) Pub. Date: Nov. 20, 2008

(54) Gas Light-Post Heater

(75) Inventors: Ken Maitland, Bowling Green, KY (US); Maureen Carroll, Atlanta, GA (US); Michael E. Docherty, Boca Raton, FL (US); Pete Moyer, Bowling Green, KY (US); Chungkin Yee, Bowling Green, KY (US); Jerry McColgin, Westfield, IN (US); Griffin Bland, Bowling Green, KY (US); Jeff Clack, Bowling Green, KY (US)

Correspondence Address: MIDDLETON & REUTLINGER, 2500 BROWN & WILLIAMSON TOWER, LOUISVILLE, KY, 40202, US

(73) Assignee: DESA IP, LLC, Miami, FL (US)

(21) Appl. No.: 11/684,755

(22) Filed: Mar. 12, 2007

(51) Int. Cl. F21V 33/00

(52) U.S. Cl. 362/93

(57) ABSTRACT

In one embodiment the instant invention combines a post having a light at its top and a heater in its middle. In one embodiment, the post has a cabinet below the heater. The cabinet may contain the fuel source of the invention so that the heater may be easily portable. In one embodiment, a wind shield protects the heater so that the heat source will not be extinguished. In one embodiment, the light and the heater have separate controls and are separately operable.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

### Field of the Invention

The present invention relates to a light post heater. More particularly, the invention relates to a portable combination light post and heater.

### BRIEF DESCRIPTION OF THE DRAWINGS

The aspects and advantages of the present invention will be better understood when the detailed description of the preferred embodiment is taken in conjunction with the accompanying drawings, in which:

FIG. 1 is a perspective view of one embodiment of the invention;

FIG. 2 is an exploded view of one embodiment of the invention;

FIG. 3 is an exploded view of the heater components of one embodiment of the invention;

FIG. 4 is an exploded view of the top cap assembly and spacer assembly of the invention;

FIG. 5 is a view of the spacer assembly; and

FIG. 6 is a dissasembled perspective view of the light post heater of the invention.

### DETAILED DESCRIPTION OF THE DRAWINGS

While this invention is capable of embodiments in many different forms, multiple embodiments are shown in the figures and will be herein described in detail. The present disclosure is to be considered an exemplification of the principles of the invention and is not intended to limit the broad aspects of the invention to the embodiments illustrated.

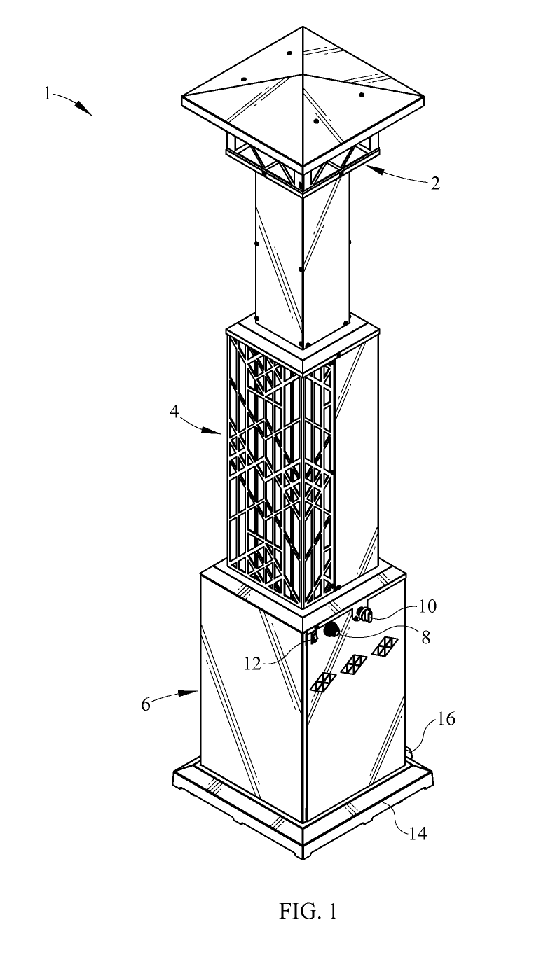

Referring now to FIG. 1, in one embodiment the light post heater 1 of the invention comprises a gas light 2, a burner assembly 4, and a cabinet assembly 6. The gas light 2 is positioned at the top of the light post heater 1, and the burner assembly 4 is positioned in the middle in order to allow heat to radiate outward from the burner assembly 4 and toward a person's torso. In FIG. 1, the cabinet assembly 6 is positioned at the bottom of the light post heater 1 and is large enough to securely store a propane tank or other energy source for the heater 1.

The embodiment of the invention shown in FIG. 1 also has a heater ignitor switch 8, a heater control knob 10, and a light power switch 12 on the outside of the cabinet assembly 6. These various controls allow the gas light 2 and the burner assembly 4 to be used and controlled separately. For example, lighting the gas light 2 may not be necessary or desirable during the day on which the burner assembly 4 may be employed to provide warmth to a user. Similarly, the heater may be turned off or on low while the light 2 is placed in an “on” position.

Below cabinet assembly 6 is base assembly 14, which stabilizes the light post heater 1 and also has wheels 16, only one of which is visible in FIG. 1. Having wheels 16 enables the light post heater 1 to be moved on a patio or deck or other surface where it may be placed.

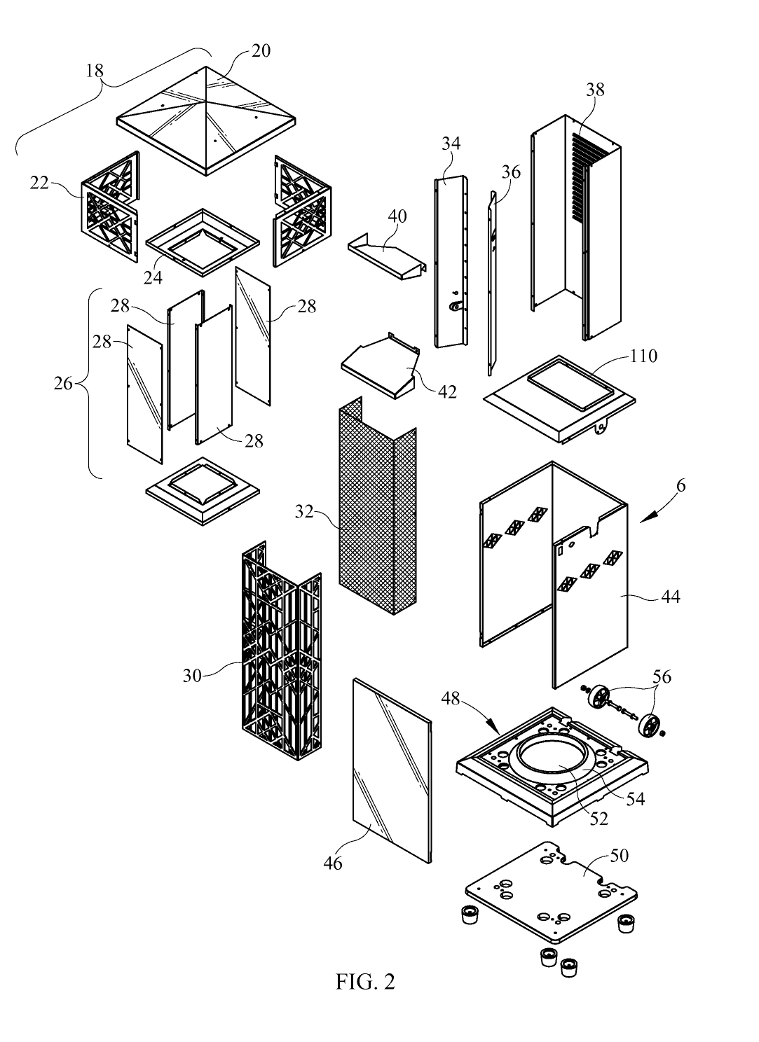

FIG. 2 shows an exploded view of the invention. The light post heater 1 of the invention has a light post cap assembly 18 at its upper end and a cabinet assembly 6 and base assembly 14 at its lower end. The light post cap assembly 18 comprises a light post top cap 20, a shroud 22, and a light post cap base 24. Within the light post cap assembly 18 is a gas light 2 (see FIG. 1), which illuminates the area around the light post 1 through the shroud 22.

Referring once again to FIG. 2, a light post spacer assembly 26 is below and adjacent to the light post cap 18 assembly. The light post spacer assembly 26 comprises four panels 28 that can be joined together to form a hollow rectangular structure having openings at the top and bottom. When the light post spacer assembly 26 is attached to the light post cap assembly 18, its top opening attaches to the light post top cap base 24. In this embodiment, the light post spacer assembly 26 may be substantially hollow in order to have space for wiring and other connections of gas light 2.

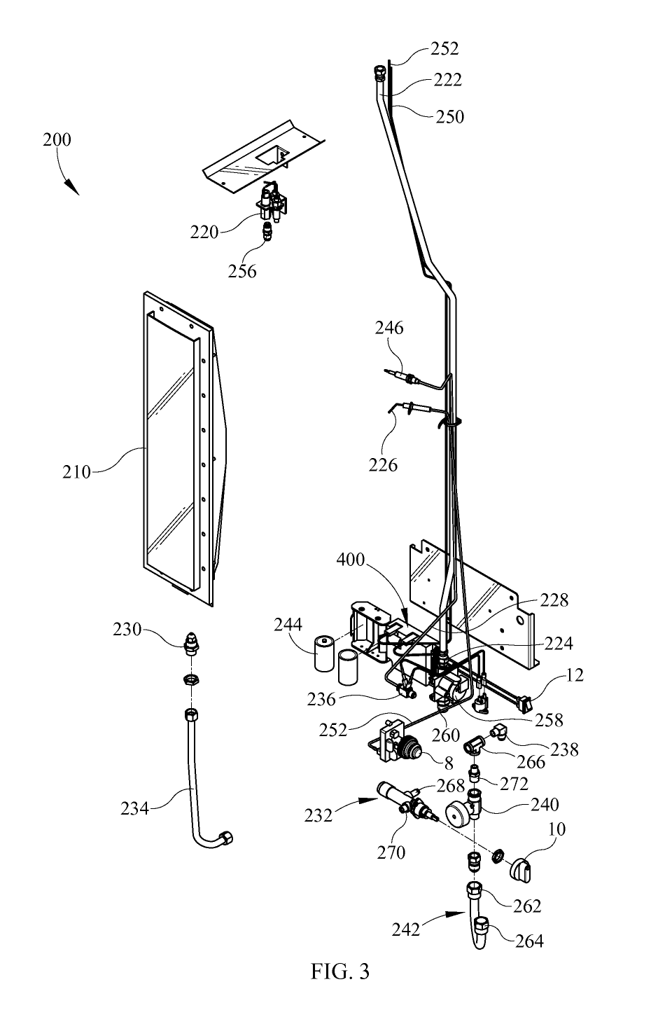

The spacer assembly 26 ensures that there is space between the burner assembly 4 and the gas light 2. Below the light post spacer assembly 26 is a burner assembly 4, which in FIG. 3 is broken down into its component parts. The burner assembly contains a main burner 210 (not shown in FIG. 2) that radiates heat. In one embodiment, gas flows up into the burner 210 at a constant pressure of 1 pound per square inch, which is maintained by a hose and regulator (not shown). The constant pressure provides for even burning at all parts of burner 210.

In addition to a burner 210, as shown in FIG. 2, the burner assembly 4 comprises a front grate 30, a screen 32 positioned between the grate 30 and the burner 210, a burner housing 38 and a reflector assembly comprising a left reflector 34, a right reflector 36, a reflector top 40 and a reflector bottom 42. The front gate 30 and screen 32 both shield the burner 210 from the weather and other interference. The left reflector 34, right reflector 36, reflector top 40, and reflector bottom 42 all focus heat toward the front gate 30 and screen 32. In one embodiment, the burner assembly 4 (see FIG. 1) is low enough so that heat radiates mainly out towards a person's lower torso when they are standing. The reflector assembly also helps to focus heat on the side of the burner assembly 4 on which the screen 32 (see FIG. 2) and grate 30 (see FIG. 2) are placed and reflect heat in this area.

The heat source of the invention within the burner assembly can be a number of different burner embodiments. FIG. 3 shows the gas assembly 200 of the invention, which comprises the gas light 2 and the main burner 210, among other things. In FIG. 3, the main burner 210 is a wire mesh emitter. Because the invention is primarily for outside use, its components must be able to withstand the elements, including cold temperatures, wind and rain. Wire mesh heaters are durable and efficient and are used in a particularly preferred embodiment of the invention. However, many types of heaters may be utilized. In addition, the reflector assembly, screen 32 (see FIG. 2), and grate 30 (see FIG. 2) partially shield the burner from the effects of the elements and prevent wind from extinguishing the burner when it is lit.

Referring again to FIG. 3, the gas assembly 200 comprises a main burner 210 and a gas light burner 220. Gas light burner 220 is the burner for gas light 2 (see FIG. 1), and it is joined to a gas source through a series of connections. Gas light burner 220 connects to light post burner flex line 222 via a first compression fitting 256. The burner flex line 222 extends downward and connects to the top light burner valve 258 by way of a second compression fitting 224. A third compression fitting 260 on top light burner valve 258 attaches to a valve fitting 262 of valve flex line 242. A hose and regulator (not shown) from a propane tank (not shown) attach to elbow fitting 238, which in turn attaches to an outlet T fitting 266, which connects to first fitting 268 of main burner control valve 232. Outlet T fitting 266 also attaches to a fourth compression fitting 272, which attaches to manual shutoff valve 240.

Turning to gas light 2, when gas light power switch 12 is depressed, an electronic signal goes from battery 244 or other power source to control module 400 to ignitor wire 252 to trigger a spark. The spark from ignitor wire 252 ignites the gas flowing through burner flex line 222 to gas light burner 220. If gas light 2 blows out, sensor wire 250 senses the absence of heat in the gas light 2 and signals top light burner valve 258 to stop the flow of gas to gas light burner 220.

Main burner 210 has a separate burner ignitor electrode 226 and a thermocouple sensor 246 that detects whether or not main burner 210 is operating. The thermocouple sensor 246 sends a signal through thermocouple wire 228 and connector 236 to main burner control valve 232 to stop the flow of gas to the main burner 210 if burner 210 does not light or goes out. A second fitting 270 extends from the main burner control valve 232 on the opposite side of first fitting 268 and connects to main burner tube 234, which ultimately connects to main burner orifice 230 and main burner 210. After the heater control knob 10 has been pressed and turned so that gas will flow into the burner 210, electronic ignitor 8 can be pressed so that battery 244 or another power source provides electricity to ignitor electrode 226. Electricity proceeds from the battery through radiant ignitor wire 252 to ignitor electrode 226 so that ignitor electrode 226 will spark. At the same time, gas travels up through main burner tube 234 and into the main burner 210 where the gas is lit by a spark from ignitor electrode 226.

As described above, main burner 210 and gas light 2 have separate controls—electronic ignitor 8 and heater control knob 10 for the burner; gas light power switch 12 for the gas light—so that gas light 2 and main burner 210 are separately operable. For example, if a user wants to use the gas light 2 on a summer night but not employ the main burner 210, he or she can do so. Alternatively, if a user wants to warm himself on a chilly day, he can light main burner 210 by turning heater control knob 10 and pressing electronic ignitor 8.

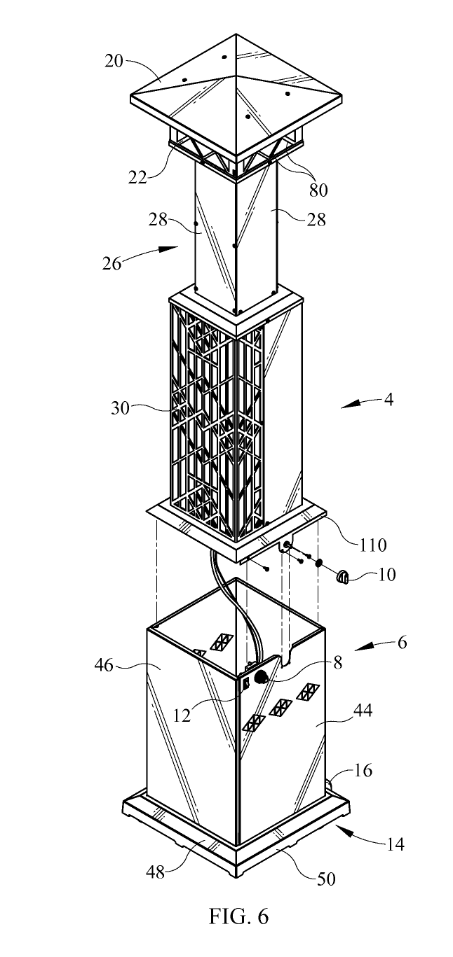

Turning again to FIGS. 1 and 2, the light post heater 1 further comprises a cabinet assembly 6 located below the burner assembly 4. The cabinet assembly 6 comprises a cabinet base 44, a cabinet base top 110 and a cabinet door 46. The cabinet assembly 6 is designed to store a propane tank or other energy source for the main burner 210 and gas light 2 so that the light post heater 1 is mobile. The cabinet assembly 6 of FIG. 6 further comprises a base assembly 14, which has a light post base 48 and a base weight 50, and the shape and size of the base 48 and base weight 50 both ensure that a propane tank or other energy source will fit well in the cabinet assembly 6 and not wobble or move substantially within it. In FIG. 2, the light post base 48 has a recessed area 52 with a lip 54 on it that is designed to hold a 20 pound propane tank.

The ability of the cabinet assembly 6 to hold an energy source allows the light post heater 1 to be mobile. Since the energy source is self-contained, the light post heater 1 does not have to be plugged in to an electrical outlet or connected by tubing to an external source. In addition, as shown in FIG. 2, the base 48 of the cabinet has wheels 26 so that the heater can be readily moved. The cabinet assembly 6 is sturdy enough for the light post heater 1 to be left outside for extended periods of time without it being damaged, but if the heater 1 is used at a restaurant or other public venue, it can be moved indoors after closing time or to specific areas where needed.

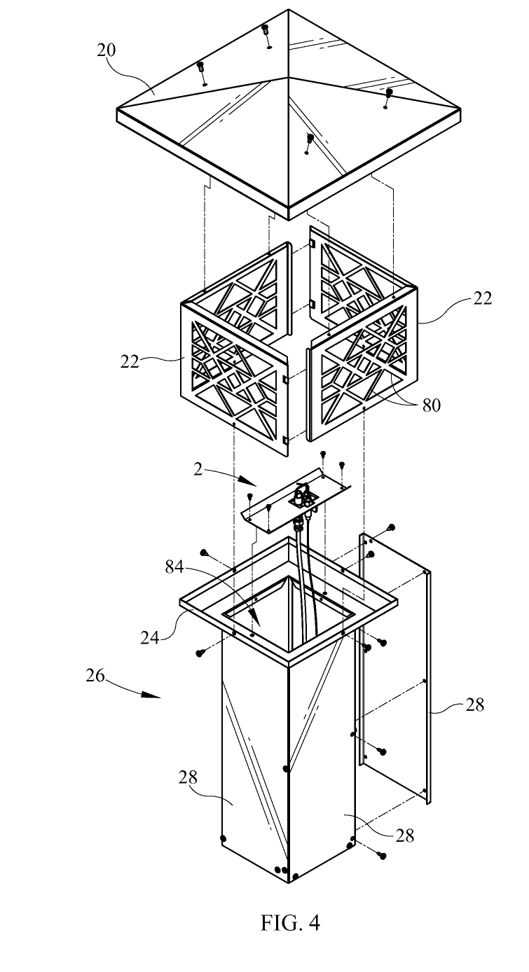

FIG. 4 shows an isolated view of the light post spacer assembly 26 and light post cap assembly 18. As shown in FIG. 4, the light post heater 1 of the invention further comprises a lightpost top cap 20, a light post spacer assembly 26, and a decorative shroud 22. As shown in FIG. 4, the shroud 22 may be formed from multiple pieces. Within the light post cap assembly 18 is gas light 2, which in the exploded view of FIG. 4 is located above the spacer assembly 26. The light post top cap 20 covers the gas light 2 and shields it from rain or inclement weather. The shroud 22 also protects the gas light 2 by covering it somewhat, but the shroud 22 also has a number of apertures 80 that allow light to escape. The light post spacer assembly 26 of FIG. 4 comprises four panels 28 that form a rectangular opening 84 through which wiring and necessary tubing can be placed in order for the gas light 2 to function properly. Although the light post spacer assembly 26 shown in FIG. 4 is rectangular, such a design is not required. In the embodiment shown in FIG. 4, the light post cap assembly 18 fits on top of the spacer assembly 26, and the gas light 2 fits within the light post cap assembly.

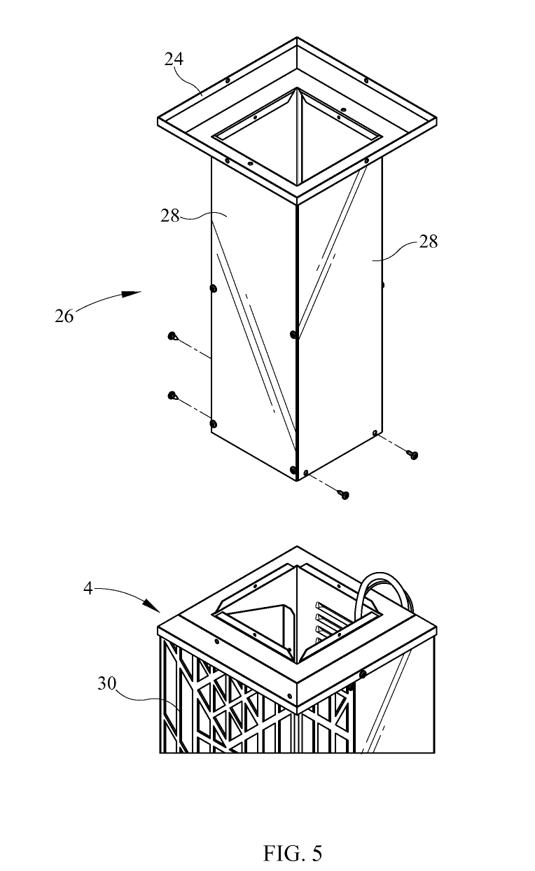

FIG. 5 shows the light post spacer assembly 26 and the burner assembly 4. The light post spacer assembly 26 can be placed on top of the burner assembly 4 and attached so that the rectangular opening 84 of the spacer assembly 26 lines up properly with burner assembly 4. Burner grate 30 is also visible in FIG. 5 on the burner assembly 4.

Turning now to FIG. 6, the burner assembly 4 is positioned above cabinet assembly 6 and is attached to the assembly 6 when the light post heater 1 is fully assembled. Cabinet assembly 6 has a gas light power switch 12 on it that controls the gas light 2. When the power switch 12 is in the “on” position, the gas light 2 will automatically light. The power switch 12 can be toggled to “off” to extinguish the gas light 2.

Positioned below the burner assembly 4 in FIG. 6 is a cabinet base top 110 to which heater control knob 10 is attached. To turn the heater on, the heater control knob 10 is pushed in and turned to the “on” position at the same time the ignitor 8 is pressed. To increase the amount of heat, the knob 10 can be rotated to a different setting.

While there have been described what are believed to be the preferred embodiments of the present invention, those skilled in the art will recognize that other and further changes and modifications may be made thereto without departing from the spirit of the invention, and it is intended to claim all such changes and modifications as fall within the true scope of the invention.

1. A portable light post heater comprising:
a light post cap assembly having a gas light situated within it;
a burner assembly comprising a main burner within said portable light post heater;
a screen positioned directly in front of said main burner to shield said main burner, and a front grate positioned directly in front of said screen to further shield said main burner;
a cabinet assembly positioned below said burner assembly; and
a self contained energy source for said burner assembly stored within said cabinet assembly.

2. The portable light post heater of claim 1 further comprising:
a first control for said gas light and a second separate control for said heater, wherein said heater and said gas light are independently operable and in fluid communication with said energy source.

3. The portable light post heater of claim 1, wherein said burner assembly further comprises a reflector assembly positioned behind said main burner.

4. The portable light post heater of claim 3, wherein said main burner is a wire mesh emitter.

5. The portable light post heater of claim 3, wherein said reflector assembly comprises a left reflector, a right reflector, a reflector top and a reflector bottom.

6. The portable light post heater of claim 1, wherein said energy source is a propane tank.

7. The portable light post heater of claim 1, wherein said cabinet assembly has wheels positioned on said cabinet assembly wherein said light post heater is portable.

8. The portable light post heater of claim 1 further comprising a spacer assembly positioned between said light post cap assembly and said burner assembly.

9. The portable light post heater of claim 8, wherein said spacer assembly comprises a hollow rectangular structure, wherein at least one connection can be made between said light post cap assembly and said burner assembly.

10. A portable light post heater comprising:
a burner assembly comprising a main burner;
a screen positioned directly in front of said main burner to shield said main burner, and a front grate positioned directly in front of said screen to further shield said main burner;
a gas light positioned above said burner assembly;
a cabinet assembly having a space for storing an energy source; and
wheels positioned on said cabinet assembly such that said portable light post heater is movable on said wheels;
a first control for said gas light and a second control for said heater, wherein said heater and said gas light are independently operable.

11. The portable light post of claim 10, wherein said front grate and screen positioned in front of said main burner permit said main burner to function without being interrupted by outside disturbances.

12. The portable light post of claim 11, wherein said burner assembly further comprises a reflector assembly positioned around said main burner opposite said front grate and said screen.

13. The portable light post of claim 12, said reflector assembly comprising a left reflector, a right reflector, a reflector top, and a reflector bottom.

14. A portable light post heater comprising:
a radiant heater in fluid communication with a gas supply;
a screen positioned directly in front of said radiant heater;
a front grate positioned directly in front of said screen;
a reflector assembly positioned adjacent to said radiant heater and opposite said screen and said front grate such that heat from said radiant heater reflects toward said screen and said front grate;
a gas light positioned above said heater; and
a self-contained energy source for said heater positioned below said heater.

15. The portable light post heater of claim 14 further comprising controls for said gas light and said radiant heater positioned on said portable light post heater, wherein said controls are independently operable.

16. The portable light post heater of claim 14, wherein said reflector assembly comprises a left reflector, a right reflector, a reflector top and a reflector bottom.

17. The portable light post heater of claim 14 further comprising a cabinet assembly in which said self-contained energy source can be stored, said cabinet assembly further having a base having wheels.

18. The portable light post heater of claim 14, further comprising a light post cap assembly above said radiant heater, wherein said gas light is positioned within said light post cap assembly.

19. The portable light post heater of claim 18 further comprising a spacer assembly between said light post cap assembly and said radiant heater.

20. The portable light post heater of claim 14, wherein said energy source is a propane tank.

21. A portable radiant heater and gas light combination containing a gas supply, comprising:
an elongated housing extending upwards from a base and containing a gas supply, said gas supply in fluid communication with a gas light and a radiant heater, said gas light positioned at an opposite distal end of said housing from said base, said radiant heater in said housing below said gas light;
a screen positioned in said elongated housing directly in front of said radiant heater and a front grate positioned in said elongated housing directly in front of said screen;
said elongated housing having a first supply line extending to said radiant heater and having a first operable control switch;
said elongated housing having a second supply line extending to said gas light and having a second operable control switch.

22. A portable heater and light assembly, comprising:
an elongated housing having a radiant heater in fluid communication with a power supply, said radiant heater having a first control operable to start and discontinue said radiant heater;
a screen positioned in said elongated housing directly in front of said radiant heater and a front grate positioned in said elongated housing directly in front of said screen;
a base at a lower end of said portable heater and light assembly and a light at an opposite distal end of said assembly, said light in operable communication with a second control operable to start and discontinue said light;
said base having at least one mobility mechanism allowing said portable heater and light assembly to be moved;
a reflector assembly surrounding said radiant heater and directing heat from said radiant heater outward toward said screen and said front grate;
wherein said power supply is a storage tank of a combustible gas and wherein said light and said heater are in fluid communication with said storage tank, said first control interposed between said storage tank and said heater, said second control interposed between said storage tank and said gas light.

23. The portable heater and light assembly of claim 22, wherein said assembly has a first supply line extending from said storage tank to a first junction, said first junction splitting said supply line into two paths, a first path to said light, a second path to said heater, said second control being on said first path, and said first control being on said second path.

24. The portable radiant heater and gas light combination containing a gas supply of claim 21 wherein said radiant heater is a wire mesh emitter.

25. The portable radiant heater and gas light combination containing a gas supply of claim 23 wherein said radiant heater is a wire mesh emitter.
